(19) United States
(12) Patent Application Publication
(10) Pub. No.: US 2003/0235672 A1
(43) Pub. Date: Dec. 25, 2003

(54) Tape and method for applying exposed pressure-sensitive adhesive to a material

(76) Inventor: Todd Manteufel, Union Grove, WI (US)

Correspondence Address: JANSSON, SHUPE & MUNGER, LTD, 245 MAIN STREET, RACINE, WI, 53403, US

(21) Appl. No.: 10/175,658

(22) Filed: Jun. 20, 2002

(51) Int. Cl. B32B 9/00; B32B 7/12

(52) U.S. Cl. 428/40.1; 428/354; 428/347; 428/346

(57) ABSTRACT

An adhesive tape for applying an exposed pressure-sensitive adhesive to a material is disclosed as having a heat-activated layer with a pressure-sensitive adhesive (PSA) coating. The heat-activated layer may be heat adhered to a material without damaging the adhesive properties of the PSA. A method of applying PSA to a material includes applying a PSA to a heat-activated adhesive layer, placing the layer against the material; and heating the layer so that the layer adheres to the material thereby fixing the pressure-sensitive adhesive to the material.

### FIELD OF THE INVENTION

This invention relates generally to double-sided tapes and, in particular, to double-sided tapes having a heat-activated and a pressure-sensitive side.

### BACKGROUND OF THE INVENTION

As is well known, there are virtually immeasurable uses for pressure-sensitive adhesive (PSA). Such adhesive is typically capable of holding together two separate surfaces of like or dissimilar characteristics. Unfortunately, while PSA performs well in a large number uses and with a large number of diverse materials, there are certain situations where PSA fails either to properly bond two separate surfaces, or to adhere to a first surface for later adhesion to a second surface.

Such a situation is frequently encountered when using Ethylene/Propylene/Diene/Methylene rubber (EPDM), foam or other like synthetic or natural materials. For instance, in the automotive industry a large number of manufacturers and assemblers use EPDM to provide secure fittings between metal, fiberglass or plastic components which reduces the “rattle” created by vibrations between such components when the automobile is driven.

Usually, the EPDM or other fitting material is held in place due to the pressure between the two automotive components. However, during assembly, before the components are in close contact, the fitting material must be held in place in another manner. Because it is very difficult for an assembler to hold the fitting material and guide the components together, typically some type of adhesive is used to hold the fitting material to the surface of one of the components.

Typically, the adhesive is contacted to the fitting material before it is contacted to one of the components for pressure adhesion. While the PSA typical bonds well to the automotive component, it often separates from the fitting material due to surface characteristics of the EPDM, foam or like material. While such separation may be avoided by positioning the adhesive on the fitting material immediately before connection to the automotive component, such a step in the assembly process is time consuming and labor intensive and requires an automotive component assembler to handle adhesive. Such a procedure is unacceptable in the automotive industry.

Therefore, there is a need in the field of adhesives for the development of an adhesive or adhesive tape assembly which will enable the placement of a PSA onto a material such as EPDM, foam or the like such that the PSA is exposed and ready for attachment to another element to effect bonding between the material and the element.

While such a need is discussed in relation to the automotive assembly industry, it is understood that an adhesive or adhesive tape assembly which satisfies the above stated need would be benefit many diverse fields in which materials having poor compatibility with typical PSAs are nevertheless used in conjunction with PSAs.

### OBJECTS OF THE INVENTION

It is an object of the invention to provide a tape which provides an exposed (outwardly-facing) PSA which has an underside connected with respect to a material which exhibits poor compatibility with PSAs.

Another object of the invention is to provide a tape which adheres to non-PSA compatible material via heat-activated adhesive (HAA) and provides a PSA surface for adhesion between the material and another element.

Another object of the invention is to provide a tape which includes a PSA and a HAA layer which are directly connected to one another.

Another object of the invention is to provide a tape which consists of a PSA and a HAA layer.

Another object of the invention to provide an adhesive tape which includes a HAA layer, a PSA and a release liner covering the PSA to prevent unintentional attachment.

Still another object of the invention is to provide a method of applying PSA to a material for connection between the material and an element.

Another object of the invention is to provide a method of applying PSA to a material for connection between the material and an element which does not require pressure-sensitive adhesion between the PSA and the material.

Another object of the invention is to provide a method of adhering a material to an element via pressure-sensitive and heat-activated adhesion.

Yet another object of the invention is to provide non-PSA compatible materials the ability to hold PSA for attachment to another element.

How these and other objects are accomplished will become apparent from the following descriptions and the drawings.

### BRIEF SUMMARY OF THE INVENTION

This invention is a novel adhesive tape for attaching a PSA to a non-PSA compatible material via an HAA layer. The tape allows the PSA to be exposed while attached to the material to enable connection between the material and another element. The invention represents a significant advance over the state of the art by providing a novel combination of elements and a novel configuration thereof.

The adhesive tape comprises an HAA layer and a PSA. The HAA has a bottom surface for heat adhesion to the intended material, which is preferably EPDM or foam, and a top surface. The PSA has a lower surface which is bonded to the top surface of the HAA and an upper surface. The upper surface is exposed when the PSA is intended to be adhered to another element to allow bonding between the material and the element.

It is preferred that the HAA layer be a polypropylene sheet. The sheet is preferably coated with the PSA to comprise the tape. The invention preferably further comprises a release liner connected to and removable from the PSA.

The preferred adhesive tape allows the HAA layer to be heated without damaging the PSA. The heating of the HAA layer may be performed by application of heat through the release liner and PSA or by application of heat directly to the bottom side of the HAA layer, possibly through the material intended to be adhered. Regardless of the heating method, the PSA retains its adhesive qualities and is effective in adhering to another element.

The invention can also be described as an adhesive tape for applying an exposed (outwardly-facing) pressure-sensitive adhesive to a material such as EPDM, foam or the like. The tape comprises an HAA layer which has a top and bottom surface and a PSA which has lower and upper surfaces. The bottom surface of the HAA layer is capable of adhering to the intended material when heated and the lower surface of the PSA is bonded to the top surface of the HAA layer. The construction of the tape allows it to be placed on the material and the HAA layer heat adhered to the material such that the PSA provides an exposed surface for pressure adhesion to an element. The HAA is preferably a polypropylene sheet. The element may be metal, fiberglass, plastic, glass or any other substance which is intended to be adhered to the material.

In this embodiment, the tape preferably further comprises a release liner connected to and removable from the upper surface of the PSA such that heat can be applied to the heat-activated layer through the release liner and the PSA.

The invention also includes the method of applying PSA to a material for connection between the material and an element. The method preferably comprises the steps of (a) applying a pressure-sensitive adhesive to a HAA layer; (b) placing the layer against the material; and (c) heating the layer so that the layer adheres to the material thereby fixing the pressure-sensitive adhesive to the material.

The inventive method may further comprise the steps of applying a release liner to the PSA before heating and removing the release liner from the PSA before connection between the material and the element. The applying step of the method preferably comprises coating the HAA layer with the PSA.

Another embodiment of the invention comprises the further step of contacting the PSA to an element to provide for connection between the material and the element. Such a step can be performed either before a release liner is applied, or after a release liner is removed.

The heating step preferably does not affect performance of the PSA in adhering the material, which may be EPDM, foam or the like, to the element, which may be metal, fiberglass, plastic, glass or any other substance which is intended to be adhered to the material.

### BRIEF DESCRIPTION OF THE DRAWINGS

FIG. 1 is a cross section view of a tape, including a release liner, for applying an exposed pressure-sensitive adhesive to a material in accordance with the invention.

FIG. 2 is a cross section view of a tape in accordance with the invention heat adhered to a material and pressure adhered to an element.

FIG. 3 is a cross section view of an alternative embodiment of the tape in accordance with the invention.

FIG. 4 is a cross section view of another alternative embodiment of the tape in accordance with the invention.

### DETAILED DESCRIPTIONS OF PREFERRED EMBODIMENTS

Throughout the application reference is made to materials as being “non-PSA compatible.” This term describes those materials which PSA has difficulty in remaining adhered to. For instance, EPDM may be adhered to another material using PSA, however, PSA will typically remain positioned on EPDM for a far shorter time than with other more PSA-friendly materials such as glass or metal.

Before discussing the figures, it should be noted that while they are presented as cross section views of the invention, the figures are not drawn to scale and do not represent the relative thicknesses of the various layers, liners, adhesives, etc.

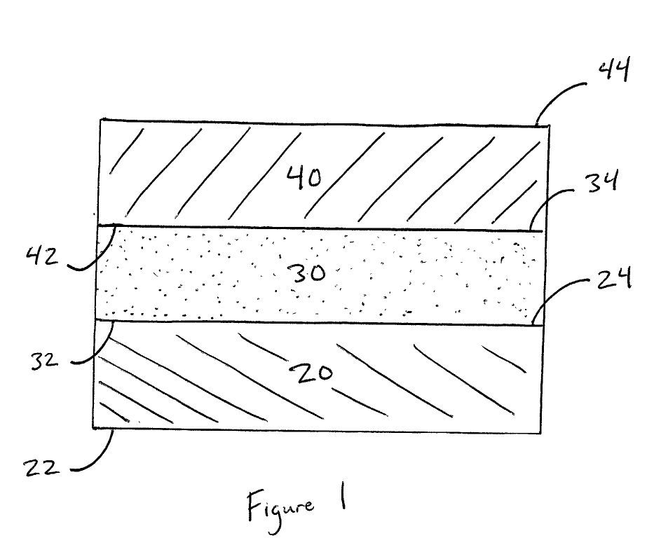

Referring to the figures, details of the tape for applying an exposed pressure-sensitive adhesive to a material will be set forth. FIG. 1 depicts a cross section view of the novel tape 10 including a release liner 40. Tape 10 comprises an HAA layer 20 which has a bottom surface 22 and a top surface 24. Top surface 24 is connected to lower surface 32 of PSA 30. PSA 30 also includes upper surface 34 which is covered by the first surface 42 of release liner 40. Release liner 40 also includes second surface 44 which is exposed to the environment.

When tape 10 is ready to be heat adhered to a material 50, bottom surface 22 is contacted to material 50 and HAA layer 20 is heated to initiate heat adhesion therebetween. Application of heat may be performed directly on HAA layer 20 or via conduction through release liner 40 and PSA 30 or through material 50. After adhesion of HAA layer 20 to material 50, material 50 with tape 10 adhered thereto may be transported or stored until connection between material 50 and another element 50 is desired. When connection between material 50 and element 60 is to be performed, release liner 40 is removed from PSA 30 thereby exposing upper surface 34 of PSA 30. Upper surface 34 is contacted to element 60 thereby connected material 50 to element 60.

In another embodiment, tape 10 does not include release liner 40 and PSA 30 is exposed upon connection between HAA layer 20 and material 50. Such an embodiment is particularly useful when no storage or transportation of tape material 50 with tape 10 is necessary.

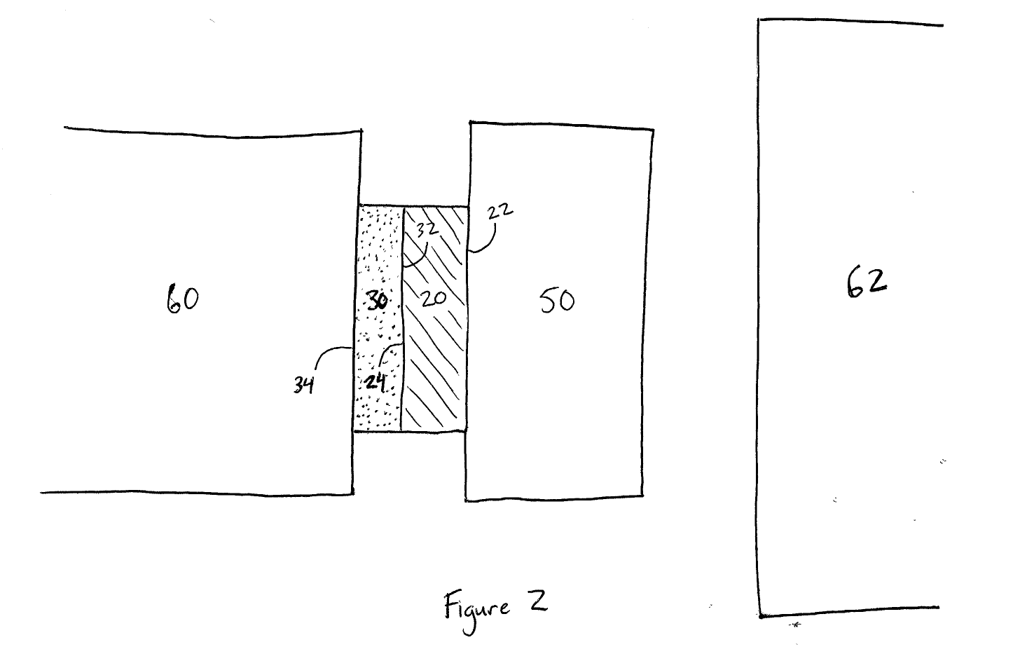

FIG. 2 is a cross section view of material 50 connected to element 60. As stated above, HAA layer 20 is heat adhered to material 50 before PSA 30 is pressure adhered to element 60. In the context of automotive assembly, PSA 30 holds material 50 against element 60 so that element 60 may be fastened to another element or component 62 (not shown in connection) with material 50 providing cushioning between the elements 60,62 and reducing rattling, or any vibrational contact between the elements 60,62.

HAA layer 20 is preferably a polypropylene sheet or film, however, HAA layer may be comprised of any heat-activatible material which can be coated with PSA and which is heat-activated at a low enough temperature such that the PSA is not damaged. HAA layer 20 preferably has a thickness of about 2 mils.

PSA 30 is preferably a silicone, rubber or acrylic-based pressure-sensitive adhesive which can be coated onto an HAA layer, such as polypropylene. PSA 30 preferably has a thickness of about 1 to 5 mils, most preferably between about 2 and 3 mils.

Material 50 may be comprised of EPDM rubber, natural rubber, foam, or any other cushioning-type material which fits between elements or components 60,62 to reduce rattling or relative movement therebetween as is known in the art. Elements 60,62 may be metal, fiberglass, plastic, glass or any other substance which is intended to be adhered to material 50.

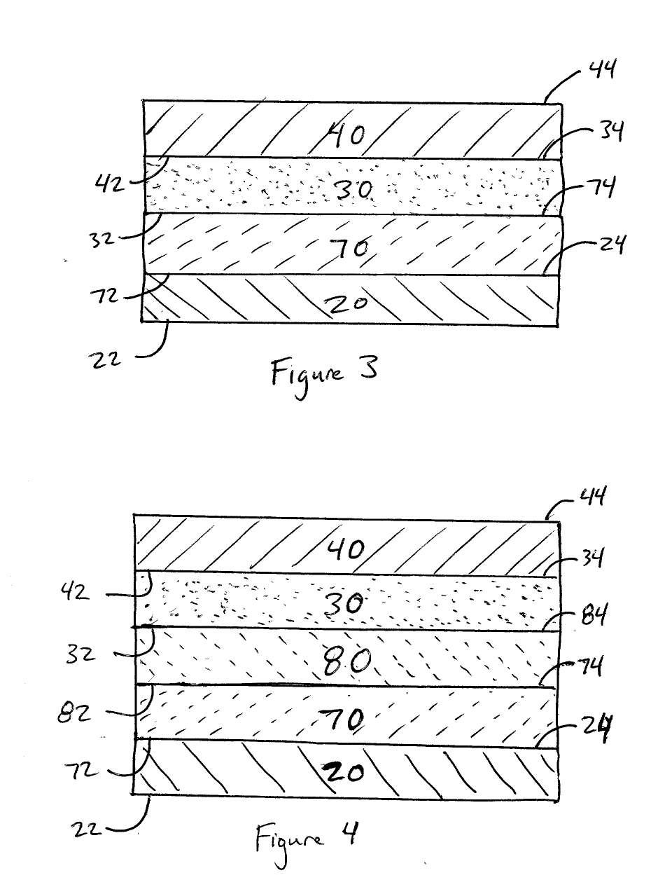

FIG. 3 depicts an alternative embodiment of the invention in which an additional adhesive 70 is used between the HAA layer 20 and PSA 30. Adhesive 70 is preferably a urethane adhesive which has a thickness of 0.5 mils or less. Urethane adhesive 70 is coated onto HAA layer 20 to increase adhesion between HAA layer 20 and PSA 30, in case such addition adhesion therebetween is necessary. Urethane adhesive 70 is particularly adept at preventing separation between HAA layer 20 and PSA 30 during heating of HAA layer 20. Urethane adhesive 70 is typically hard and non-tacky upon complete cure of the tape which occurs after the construction of tape 10 through assembly of components 20,30,70,40.

Primary surface 72 of adhesive 70 contacts top surface 24 upon coating of adhesive 70 onto HAA layer 20. Secondary surface 74 is then coated with PSA 30 such that lower surface 32 contacts secondary surface 74.

FIG. 4 shows another alternative embodiment of tape 10 which includes a film 80 positioned between adhesive 70 and PSA 30. Inclusion of film 80 provides a more rigid structure. Film 80 preferably has a thickness of 0.25 mils or more, most preferably between about 1 and 2 mils. By providing rigidity to the tape, overall peel adhesion strength is increased when the tape is bonded between a material 50 and an element 60. In addition to providing increase rigidity, film 80 offers more protection to PSA 30 against damage from heat applied to HAA layer 20. Underside 82 of film 80 contacts secondary surface 74 when film 80 is applied to adhesive 70. Topside 84 of film is coated with PSA 30 such that lower surface 32 contacts topside 84.

While the principles of the invention have been shown and described in connection with a limited number of embodiments, it is to be understood clearly that such embodiments are by way of example and are not limiting.

1. An adhesive tape for applying an exposed pressure-sensitive adhesive to a material, the tape comprising:
a heat-activated adhesive layer having a top and bottom surface, the bottom surface capable of adhering to the material; and
a pressure-sensitive adhesive having lower and upper surfaces, the lower surface bonded to the top surface.

2. The adhesive tape of claim 1 wherein the heat-activated layer is a polypropylene sheet.

3. The adhesive tape of claim 2 wherein the polypropylene sheet is coated with the pressure-sensitive adhesive.

4. The adhesive tape of claim 3 further comprising a release liner connected to and removable from the pressure-sensitive adhesive.

5. The adhesive tape of claim 1 wherein the material is rubber.

6. The adhesive tape of claim 1 further comprising a release liner connected to and removable from the upper surface.

7. The adhesive tape of claims 1 wherein the heat-activated layer can be heated without damaging the pressure-sensitive adhesive.

8. An adhesive tape for applying an exposed pressure-sensitive adhesive to a material, the tape comprising:
a heat-activated adhesive layer having a top and bottom surface, the bottom surface capable of adhering to the material when heated; and
a pressure-sensitive adhesive having lower and upper surfaces, the lower surface bonded to the top surface;
whereby the tape can be placed on the material, the heat-activated adhesive layer can be heat adhered to the material and the pressure-sensitive adhesive can provide an exposed surface for pressure adhesion to an element.

9. The adhesive tape of claim 8 further comprising a release liner connected to and removable from the upper surface and wherein heat can be applied to the heat-activated layer through the release liner.

10. The adhesive tape of claim 8 wherein the material is foam.

11. The adhesive tape of claim 10 wherein the element is metal.

12. The adhesive tape of claim 8 wherein the heat-activated layer is a polypropylene sheet.

13. The adhesive tape of claim 12 wherein the polypropylene sheet is coated with pressure-sensitive adhesive.

14. A method of applying pressure-sensitive adhesive to a material for connection between the material and an element, the method comprising:
applying a pressure-sensitive adhesive with respect to a heat-activated adhesive layer;
placing the layer against the material; and
heating the layer so that the layer adheres to the material thereby fixing the pressure-sensitive adhesive to the material.

15. The method of claim 14 further comprising the step of applying a release liner to the pressure-sensitive adhesive before heating.

16. The method of claim 15 further comprising the step of removing the release liner from the pressure-sensitive adhesive before connection between the material and the element.

17. The method of claim 14 wherein the layer is a polypropylene sheet.

18. The method of claim 14 wherein the layer is coated with pressure-sensitive adhesive during the applying step.

19. The method of claim 14 wherein the heating step does not affect performance of the pressure-sensitive adhesive.

20. The method of claim 14 wherein the material is rubber and the element is metal.
